(19) United States
(12) Patent Application Publication
(10) Pub. No.: US 2017/0155415 A1
(43) Pub. Date: Jun. 1, 2017

(54) POSITIONING STRUCTURE FOR A HANDHELD ELECTRONIC DEVICE

(71) Applicant: Gwo-Jye YAN, Taipei City (TW)

(72) Inventor: Gwo-Jye YAN, Taipei City (TW)

(21) Appl. No.: 15/275,516

(22) Filed: Sep. 26, 2016

(30) Foreign Application Priority Data
Nov. 30, 2015 (TW) 104139968
Nov. 30, 2015 (TW) 104139971

(51) Int. Cl. H04B 1/3827; H04M 1/02; A45F 5/00; A45C 11/00; A45F 5/02

(52) U.S. Cl. CPC H04B 1/385; A45C 11/00; A45F 5/021; A45F 5/00; H04M 1/0202; A45C 2011/002; A45F 2005/008

(57) ABSTRACT

The present invention is to provide a positioning structure for a handheld electronic device, which comprises a case being a rear case of the handheld electronic device or a protective case attached to the rear case, and two studs installed to the rear side of the case at positions adjacent to center and side edge of the case, respectively. The studs respectively include a stud pillar having one end fixed to the rear side of the case and a stud head having one end connected to the other end of the stud pillar, and maximum cross section of the stud head is larger than cross section of the stud pillar, so that the studs can be vertically standing on the rear side of the case, for enabling the case to be stably positioned on a wristband structure within a hand reachable and sight visible position through the studs.

### FIELD OF THE INVENTION

The present invention relates to a positioning structure, more particularly to a positioning structure for a handheld electronic device, not only enabling the handheld electronic device to be always stably placed on a plane in a view angle suitable for a user to view information or instant message displayed on a display screen thereof, but also enabling the handheld electronic device to be securely positioned onto a wristband, so that, when the user is unavailable to hold the handheld electronic device on hand, the handheld electronic device can still be securely positioned around his or her wrist within a hand reachable and sight visible position.

### BACKGROUND OF THE INVENTION

In recent years, due to the rapid development of electronic and telecommunication technologies, the handheld electronic devices (such as mobile phone, smart phone, . . . etc.) not only have powerful telecommunication functions, but also provide a variety of practical applications (such as noting, timing, counting, scheduling, lighting, photographing, video or voice recording, GPS, mapping, statistics, conference, investment, withdrawing money from bank, shopping, booking, making reservation, chatting, social networking, playing games, . . . etc.) to meet with people's daily life, work, social and other entertainment needs. That is also the reason why the mobile phones are now becoming one of the most indispensable and important belongings to most people, especially those who living in the metropolitan areas. Almost every people always having a mobile phone on hand is also now becoming a very common scene everywhere in the metropolitan areas. Hereby taking the following iPhone Series mobile phone designed, manufactured and sold by Apple Computer, Inc. U.S.A. as examples for analyzing the reasons behind:

(1) iPhone officially launched at the date of Jun. 29, 2007 with a dimension of which the length, width and thickness are 115 mm, 61 mm and 11.6 mm, respectively;

(2) iPhone 3G officially launched at the date of Jul. 11, 2008 with a dimension of which the length, width and thickness are 115.5 mm, 62.1 mm and 12.3 mm, respectively;

(3) iPhone 4 officially launched at the date of Jun. 24, 2010 with a dimension of which the length, width and thickness are 115.2 mm, 58.6 mm and 9.3 mm, respectively;

(4) iPhone 5 officially launched at the date of Sep. 21, 2012 with a dimension of which the length, width and thickness are 123.8 mm, 58.6 mm and 7.6 mm, respectively;

(5) iPhone 6 officially launched at the date of Sep. 19, 2014 with a dimension of which the length, width and thickness are 138.1 mm, 67.0 mm and 6.9 mm, respectively; and

(6) iPhone 6 Plus officially launched at the date of Sep. 9, 2015 with a dimension of which the length, width and thickness are 158.1 mm, 77.8 mm and 7.1 mm, respectively.

In view of the above, in order to satisfy the irreversible inclination that people must frequently use their mobile phones in their daily lives, the designs of iPhone series have been significantly transformed from the past compact dimension (the first-generation iPhone's length×width×thickness is 115×61×11.6 mm 3) to a larger but thinner dimension (the latest generation iPhone 6 Plus's length×width×thickness is now 158.1×77.8×7.1 mm 3), so as to let people more easily and readily hold their mobile phones on hand as well as more easily and clearly browse websites and view information or instant message displayed on the big screen thereof. This dimensional inclination has also driven other mobile phone designing and manufacturing companies in the world to follow thereafter, so that the slim body with big screen has now become a mainstream of the smartphones and also causes the new generation of smartphones now no longer suitable for being put into pocket of a user's cloth or pants as the old compact mobile phones used to be. It's no wonder that almost every people always having a smartphone on hand is now a very common scene everywhere in streets of metropolitan areas all over the world. Though, holding a smartphone on hand seems inexplicably to satisfy many people's needs, however, when using the smartphone with a slim body and a big screen on hand, people often have to encounter the following inconveniences and problems:

(1) Walking in metropolitan area in sunshiny days, when holding a smartphone on hand and making a phone call or browsing websites, often resulting in accidentally hitting other people or object on the road due to excessively focusing on calling or browsing or in a hurry action, causing the smartphone thrown away from hand and falling to ground, and seriously damaging the smartphone or the display screen thereof, sometimes, even completely destroying the smartphone due to a vehicle (such as wagon, bicycle, motorcycle or car . . . etc.) passing by. Under this circumstance, in addition to heartbreaking pain for the loss of all files and information stored in the smartphone, the user is also unable to request the innocent people passing by for the damage of the smartphone.

(2) In rainy days, walking in the metropolitan area with one hand holding an umbrella and the other hand carrying a briefcase or bag, when hearing phone rings from a smartphone placed in the pocket of cloth or pants and scrambling to take the smartphone out from the pocket, the smartphone is inadvertently slipping off the hand and falling into a puddle on the street, causing the smartphone unable to be used due to a short circuit. Under this circumstance, in addition to the heartbreaking pain for losing all precious files and information stored in the smartphone, the user can only complain to the God.

(3) Standing in public transportation (such as bus, train or MRT), with one hand grasping a hanging handle or handrail and the other hand holding a smartphone and browsing web sites or having a phone call, it is often that, due to a sudden shaking of the public transportation or collisions by the hurrying on and off passengers, accidentally causing the smartphone thrown away from the hand and heavily falling to the ground, causing serious damages to the smartphone or the display screen thereof, and even completely destroying the smartphone after it has been trampled by the hurrying on and off passengers passing by. Under this circumstance, in addition to the heartbreaking pain for losing the precious files and information stored in the smartphone, there is no recourse can be requested for compensation.

(4) The incidents happening in our daily lives similar to the aforementioned circumstances are abundant and hard to be detailedly described here, however, according to statistics, most people often encountered circumstances of losing their smartphones in public places (such as restaurants, stores, playgrounds or libraries . . . etc.). In general, most people often like to temporarily put their smartphones on seats, desktops or countertops in public places after using their smartphones and, then suddenly thinking of doing something (such as taking food, inquiring price, replacing something, finding book or going to the toilet, . . . etc.) and unwittingly forgetting the smartphones on the seats, desktops or countertops due to their ultra-thin and flat dimensions and extremely not eye-catching configurations, especially when being flat on the seats, desktops or countertops. While recalling their memories and returning back to the lost locations, their smartphones had already been taken by malicious persons around. Under these circumstances, not only the chances for regaining their smartphones back are very slim, but also the personal and private files and information stored therein were likely to be stolen or opened to the public, which are sometimes causing unexpected damages to the owners of the smartphones far more seriously than the smartphones themselves.

Accordingly, how to design a positioning structure for a handheld electronic device so that, when a user places the handheld electronic device on a plane, the display screen of the handheld electronic device can always be stably maintained in a view angle suitable for user-friendly viewing information displayed on the screen and easily identifying the location of the handheld electronic device; how to design a positioning structure for the handheld electronic device so that the handheld electronic device can be positioned on a wristband within a reachable range of the user's hand, so as to effectively prevent the handheld electronic device from being lost unexpectedly; and how to design a positioning structure for the handheld electronic device so that the handheld electronic device can also be quickly and securely positioned on the wristband in a state that, when the user is unable to hold the handheld electronic device on hand, the handheld electronic device can still be securely positioned around wrist within a hand reachable and sight visible position; which are the important issues going to be discussed hereinafter by the present invention.

### BRIEF SUMMARY OF THE INVENTION

It is an objective of the present invention to provide a positioning structure for a handheld electronic device, which comprises a case being a rear case of the handheld electronic device or a protective case attached to the rear case of the handheld electronic device, and a first stud and a second stud installed to a rear side of the case along a longitudinal center line of the case and at positions adjacent to center and side edge of the case, respectively. The first and second studs respectively include a stud pillar and a stud head, one end of the stud pillar is fixed to the rear side of the case, the other end of the stud pillar is connected to one end of the stud head, so that the stud head along with the stud pillar is vertically standing on the rear side of the case, and maximum cross section of the stud head is larger than cross section of the stud pillar. Thus, when the handheld electronic device is placed on a plane, a display screen of the handheld electronic device is always maintained in a stable perspective angle with respect to the plane of which the advantages are not only able to let a user have a better view angle for viewing picture or information displayed on the display screen, but also able to let the user easily and quickly identify location of the handheld electronic device.

Another objective of the present invention is that the handheld electronic device can be attached to a positioning strap of a wristband structure by means of the second stud and maintained in position within a reachable range of the user's hand, so as not only for preventing the handheld electronic device from falling off the user's hand inadvertently, but also for enabling the user's hand to reach the handheld electronic device at any time.

Yet another objective of the present invention is to provide the positioning structure so that the handheld electronic device can be quickly and securely positioned and resting on the wristband structure within a sight visible range through the first stud and the second stud, and is not easy to be lost. Then, in case when both hands are doing work and in a state unavailable to hold the handheld electronic device, the user is still able to read information or instant message displayed on the handheld electronic device. At this moment, since the first stud is fixed to the position adjacent to gravity center of the handheld electronic device and hitched to a wristband of the wristband structure, and the second stud is fixed to the position adjacent to the side edge of the handheld electronic device and attached to the positioning strap of the wristband structure, therefore, when the handheld electronic device is positioned and resting on the wristband structure, because of hitching friction applied by the wristband to the first stud and constraining force applied by the positioning strap to the second stud, the handheld electronic device can be stably positioned and resting on the wristband in a state less susceptible to shaking, and the position and orientation of the handheld electronic device can also be adjusted for enabling the user to clearly view the information or instant message displayed on the display screen accordingly.

### BRIEF DESCRIPTION OF THE DRAWINGS

The features, objectives and advantages in conjunction with the subject matters claimed in the present invention will be best understood by reference to the structures as well as the preferred embodiments clearly described and shown in the following detailed description and the accompanying drawings thereof:

FIG. 1 is a perspective view of a positioning structure for a handheld electronic device of the present invention;

FIG. 2 shows a use status of the positioning structure along with the handheld electronic device placed on a plane;

FIG. 3 is a perspective view of other embodiment of the positioning structure;

FIG. 4 is a perspective view of a wristband structure of the present invention;

FIG. 5 is a perspective view of another embodiment of the wristband structure;

FIG. 6 is a perspective view of the other embodiment of the wristband structure;

FIG. 7 shows a folded status of a positioning strap of the wristband structure;

FIG. 8 shows a use status of the handheld electronic device attached to the wristband structure;

FIG. 9 is a use status of the handheld electronic device temporarily and firmly positioned on a wristband of the wristband structure;

FIG. 10 is another use status of the handheld electronic device temporarily and firmly positioned on the wristband;

FIG. 11 is a cross-sectional view of a second fastener of the wristband structure in an unlock state;

FIG. 12 is a cross-sectional view of the second fastener in a lock state;

FIG. 13A is a side view of a stud head in sphere shape or mushroom shape of the present invention; and

FIG. 13B is a side view of a stud head in double cone shape of the present invention.

### DESCRIPTION OF THE EXEMPLARY EMBODIMENTS

As mentioned above, the thinner body adapted for grip and the larger screen adapted for viewing have now become an irreversible design inclination of the mobile phone or smartphone. Accordingly, the bigger size of the mobile phone is in turn no longer suitable for being placed in pocket of user's cloth or pants, no wander almost every person holding a bigger size mobile phone on hand is now naturally becoming an extraordinary scene everywhere in the metropolitan areas of the world. Due to the thinner structure of the mobile phone, the mobile phone is also unable to be installed an additional positioning structure therein, like the one installed on a conventional camera or camcorder for mounting the camera or camcorder to a cradle head of a conventional tripod. Considering the limited and narrow space in the thinner structure of the mobile phone, the inventor thinks of designing a minimized and simplified positioning structure in order to effectively solve the aforementioned inconveniences and problems which most users often encountered.

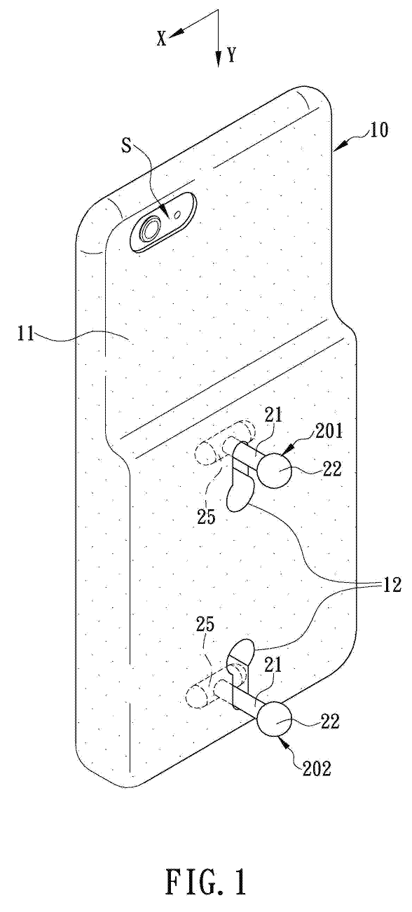

The present invention is to provide a positioning structure for a handheld electronic device. In one preferred embodiment of the present invention, as referring to FIG. 1, the positioning structure comprises a case, a first stud (such as button stud) 201 [symbol] a second stud 202, wherein the case can be a rear case 11 of the handheld electronic device S or a protective case attached to and covering on the rear case 11 of the handheld electronic device S. In subsequent description of the present invention, the handheld electronic device is also marked as“10” on behalf of the case for convenience in describing the features of the present invention.

Again referring to FIG. 1, the first stud 201 and the second stud 202 are made of metal material and in a length about 10 mm, and are installed to the rear side of the handheld electronic device 10 along a longitudinal center line Y of the handheld electronic device 10 and at positions adjacent to center and side edge of the handheld electronic device 10, respectively, wherein each of the studs 201, 202 includes a stud pillar 21 and a stud head 22, one end of the stud pillar 21 is fixed to the rear side of the handheld electronic device 10, the other end of the stud pillar 21 is connected to one end of the stud head 22, so that the stud head 22 along with the stud pillar 21 of each stud 201, 202 is vertically standing on the rear side of the handheld electronic device 10, and maximum cross section of the stud head 22 is larger than cross section of the stud pillar 21.

Again referring to FIG. 1, in the preferred embodiment of the present invention, two positioning grooves 12 are recessed on the rear side of the handheld electronic device 10 along the longitudinal center line Y of the handheld electronic device 10 and at the positions adjacent to the center and side edge of the handheld electronic device 10, respectively, wherein the first stud 201 is installed to the positioning groove 12 adjacent to the center of the handheld electronic device 10, and the second stud 202 is installed to the positioning groove 12 adjacent to the side edge of the handheld electronic device 10. The first stud 201 and the second stud 202 further include a pivotal shaft 25, respectively, and the pivotal shaft 25 is perpendicularly connected to one end of the stud pillar 21 and installed within the positioning groove 12, so that the stud pillar 21 along with the stud head 22 of each stud 201, 202 can be rotated to a state being received and lying in the positioning groove 12, or vertically standing on the rear side of the handheld electronic device 10 outside the positioning groove 12.

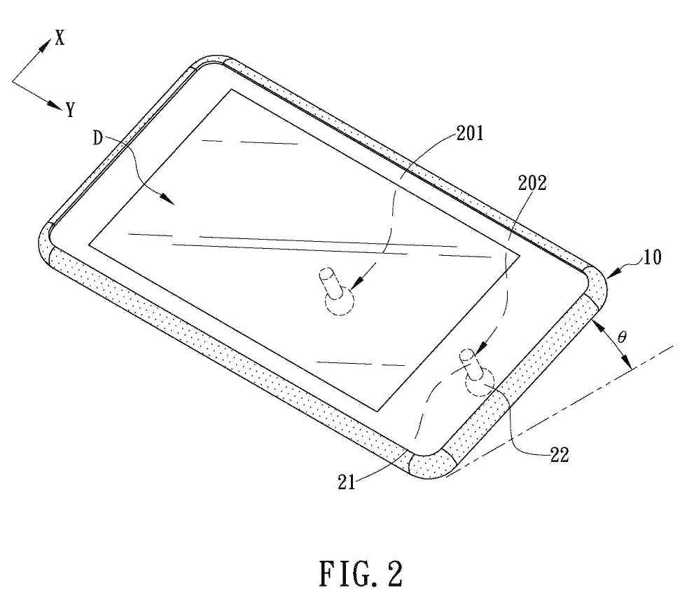

Please refer to FIG. 2, when the stud pillars 21 together with the stud heads 22 of the two studs 201, 202 are rotated to vertically standing on the rear side of the handheld electronic device 10 outside the positioning grooves 12 and the handheld electronic device 10 is then placed on a plane of a table, the two studs 201, 202 will enable a display screen D on a front side of the handheld electronic device 10 to always maintain in a stable perspective angle θ with respect to the plane. Thus, the user is not only able to always view the information or pictures displayed on the display screen D in a better view angle, but also able to quickly identify the location of the handheld electronic device 10. In addition, please again refer to FIGS. 1 and 2, since the two studs 201, 202 are respectively installed along the longitudinal center line Y of the handheld electronic device 10 at the positions adjacent to the center and side edge thereof, thus, when the handheld electronic device 10 is horizontally placed on the plane, the user only needs to gently push the top edge of the handheld electronic device 10 backwards, the handheld electronic device 10 will turn backward with respect to the longitudinal center line Y, so as to let a person sitting or standing opposite to the user easily view the information or pictures displayed on the display screen D in the same better view angle.

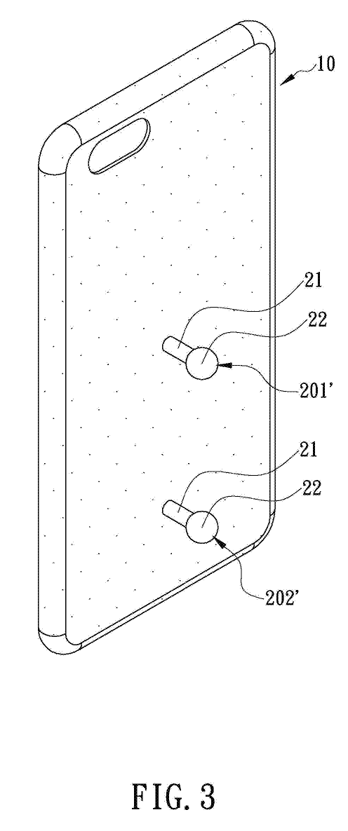

In addition, in order to let the positioning structure have a more simple structure easy for being manufactured, in another preferred embodiment of the present invention, please refer to FIG. 3, the rear side surface of the handheld electronic device 10 doesn't have the positioning grooves 12 as shown in FIG. 1, and there isn't such pivotal shaft 25 as shown in FIG. 1 and provided on the first stud 201′ and the second stud 202′ either. The ends of the stud pillars 21 of the first stud 201′ and the second stud 202′ are directly fixed to the rear side of the handheld electronic device 10 at the positions adjacent to the center and side edge thereof, respectively.

In order to enhance the performance of the positioning structure for the handheld electronic device 10 in the other preferred embodiment, the positioning structure further includes a wristband structure, so as to enable the handheld electronic device 10 not only to be always positioned within a reachable range of the user's hand, but also to be quickly and securely positioned and resting on a wristband of the wristband structure within an operable and sight visible range by means of the first stud 201 and the second stud 202. In the other preferred embodiment of the present invention, please refer to FIGS. 1, 4 and 5, the wristband structure includes a wristband 40, a first fastener 50, a hitch element 60, a positioning strap 70 and a second fastener 80, wherein the wristband 40 is made of fabric, leather or plastic band, a plurality of hitch holes 41 are formed on the wristband 40 along a longitudinal center line thereof, each of the hitch holes 41 penetrates two opposite sides of the wristband 40 and is spaced from the other, the hitch hole 41 is matched with the cross section of the stud pillar 21 and has a hitch split 42 formed along the longitudinal center line of the wristband 40 and, when the stud head 22 of the first stud 201 is embedded into the hitch hole 41 and the hitch split 42, the first stud 201 is hung onto the hitch hole 41, and the hitch hole 41 and the hitch split 42 are able to apply a hitching friction respectively to the stud pillar 21 and the stud head 22 of the first stud 201. The first fastener 50 is fixed to the wristband 40 at a position adjacent to one end of the wristband 40 and, when the other end of the wristband 40 passes through the first fastener 50, the first fastener 50 is able to fasten overlapping portions of two ends of the wristband 40 together so that the wristband 40 can then be formed as a loop for being worn onto the user's wrist.

The hitch element 60 includes a pivotal pillar 61, a hitch pillar 62, a hitch head 63 and a pivotal ring 64, wherein one end of the pivotal pillar 61 is fixed to the outside of the wristband 40 at a position adjacent to the center of the wristband 40, the pivotal pillar 61 has a pivotal hole 610 provided thereon and penetrating the pivotal pillar 61 along the diameter of the pivotal pillar 61, the other end of the pivotal pillar 61 is connected to one end of the hitch pillar 62, the other end of the hitch pillar 62 is connected to the hitch head 63, maximum cross section of the hitch head 63 is greater than cross section of the hitch pillar 62, and the pivotal ring 64 is pivotally connected to the pivotal hole 610, so that the pivotal ring 64 can be rotated with respect to the pivotal hole 610. The positioning strap 70 includes a connecting strap 71 and a retaining element 72, wherein length of the connecting strap 71 is matched with maximum length of user's hand (including palm and middle finger), the retaining element 72 is fixed to the connecting strap 71 at a position adjacent to one end of the connecting strap 71, the other end of the connecting strap 71 can pass sequentially through the pivotal ring 64 and the retaining element 72 so that the connecting strap 71 can be hung on the pivotal ring 64, and the retaining element 72 can exert a position limiting friction to the connecting strap 71, so as to limit the displacement of the other end of the connecting strap 71 and enable the user to easily adjust a hanging length of the positioning strap 70 between the hitch element 60 and the second fastener 80. The second fastener 80 is fixed to the other end of the connecting strap 71 and can be fastened to the hitch pillar 62 in a lock state unable to disengage from the hitch head 63 so as to shorten the hanging length of the positioning strap 70, or can be released from the hitch pillar 62 in an unlock state disengaged from the hitch head 63 so as to extend the hanging length of the positioning strap 70.

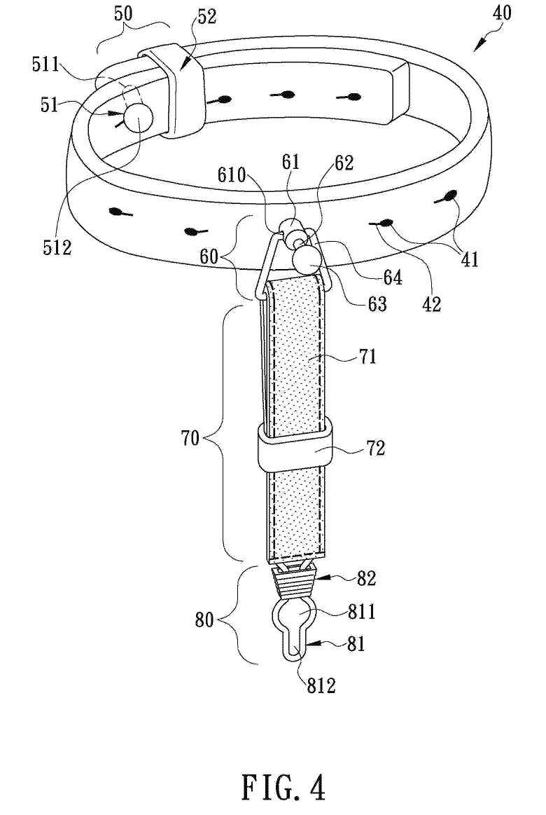

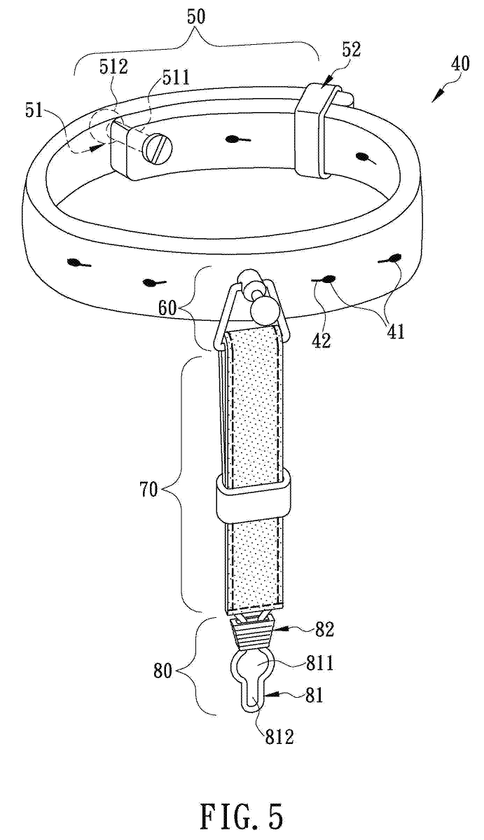

Please again refer to FIGS. 4 and 5, in the other preferred embodiment of the present invention, the first fastener 50 includes a third stud 51 and a retaining collar 52, the third stud 51 includes a third pillar 511 and a third head 512, one end of the third pillar 511 is fixed to the wristband 40 at a position adjacent to one end of the wristband 40, one end of the third head 512 is connected to the other end of the third pillar 511, maximum cross section of the third head 512 is greater than cross section of the third pillar 511, and the cross section of the third pillar 511 is matched with the hitch hole 41.

As referring to FIG. 4 again, the retaining collar 52 is fixed to the wristband 40 at a position adjacent to the third stud 51 and, when the other end of the wristband 40 passes through the retaining collar 52, the third head 512 is able to embed into the hitch hole 41 in a direction from the outside to the inside of the wristband 40 so that the third pillar 511 can be hitched by the hitch hole 41, the overlapping portions of two ends of the wristband 40 can be fastened together, and the wristband 40 can then be formed as a loop for being worn on the user's wrist. In the meantime, since the retaining collar 52 is fixed on the wristband 40 at a position adjacent to the third stud 51 and able to force the third pillar 511 to be positioned inside the hitch hole 41 and not easily taken off from the hitch hole 41.

Alternatively, please refer to FIG. 5, the retaining collar 52 can be fixed to the wristband 40 at a position adjacent to the other end of the wristband 40 and, when one end of the wristband 40 passes through the retaining collar 52, the third head 512 is able to embed into the hitch hole 41 in a direction from the inside to the outside of the wristband 40 so that the third pillar 511 is hitched by the hitch hole 41 and the overlapping portions of the two ends of the wristband 40 can be fastened together. As a result, the third head 512 is exposed outside the wristband 40 and wouldn't affect user's comfortable feeling while wearing the wristband 40.

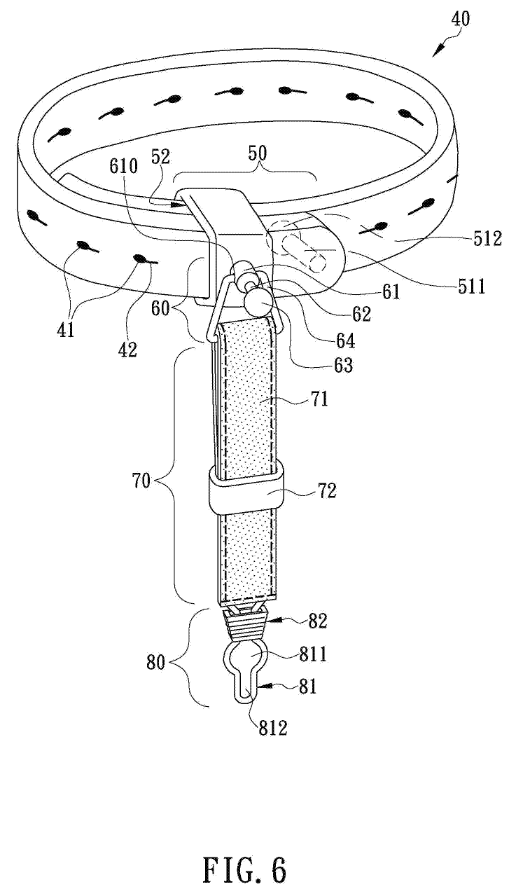

Please refer to FIG. 6, in the other preferred embodiment of the present invention, one end of the pivotal pillar 61 can be fixed to outside of the retaining collar 50, so as to effectively increase the space for forming the hitching holes 41 on the wristband 40. The above-mentioned embodiments are merely the preferred embodiments of the first fastener 50, however, the features and structures of the first fastener 50 are not limited to these, any person skilled in the art or the field of the invention using other conventional fasteners to cause the overlapping portions of the wristband 40 to be fastened together and formed as a loop should also be interpreted as the first fastener 50 mentioned in the present invention.

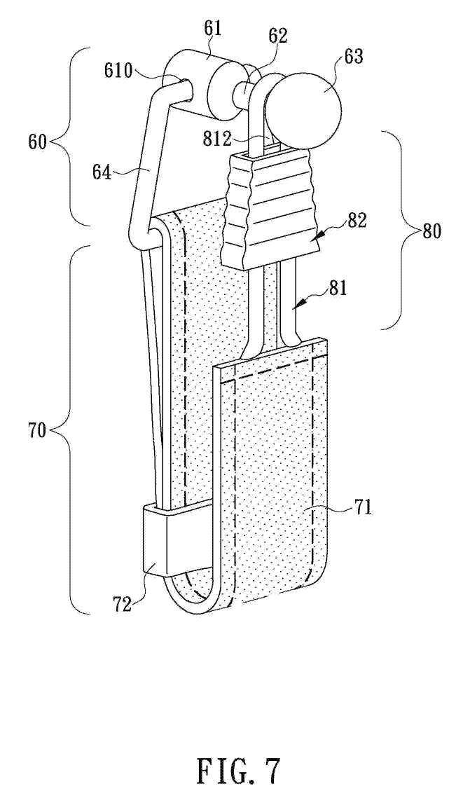

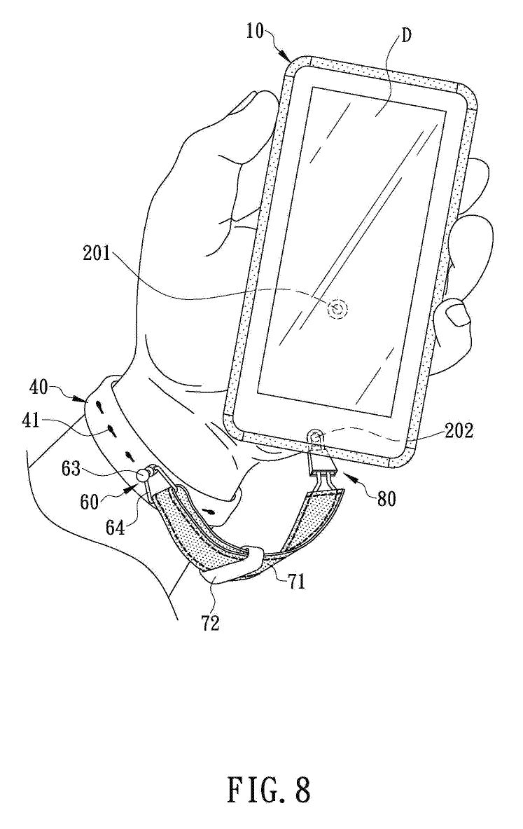

Thus, while the user does not want to use the wristband structure for connecting or hanging the handheld electronic device 10, please refer to FIGS. 1 and 7, the user only needs to fasten the second fastener 80 to the hitch pillar 62, so as to triply fold up the connecting strap 71 together and significantly reduce the hanging length of the positioning strap 70 (after being triply folded, the hanging length of the positioning strap 70 is equivalent to about one third of the hand's length) to an extent without affecting the operation of the user's hand. On the contrary, while the user wants to use the wristband structure for connecting or hanging the handheld electronic device 10, the user only needs to release the second fastener 80 from the hitch pillar 62 and, after properly adjusting the hanging length of the positioning strap 70, then fasten the second fastener 80 to the second stud 202, so that the handheld electronic device 10 can always be positioned in the reachable range of the user's hand (due to the length of the connecting strap 71 is matched with the length of user's hand). Therefore, the advantages of the invention are not only able to prevent the handheld electronic device 10 from falling out of the user's hand inadvertently, but also able to let the handheld electronic device 10 always be readily accessible to the user's hand for operation.

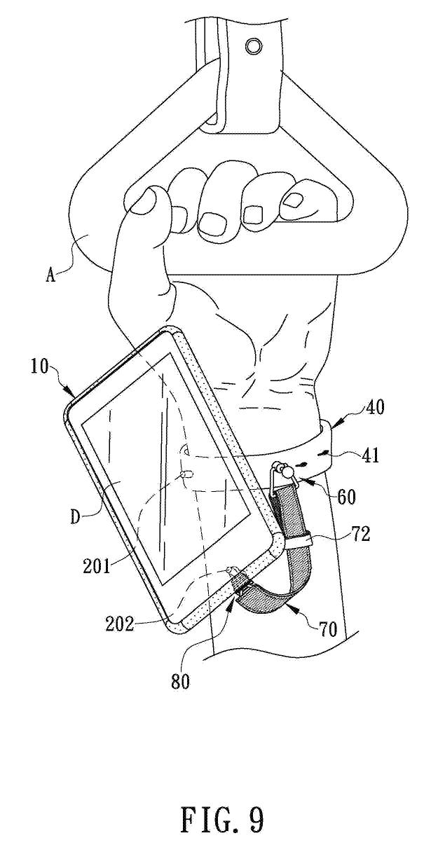

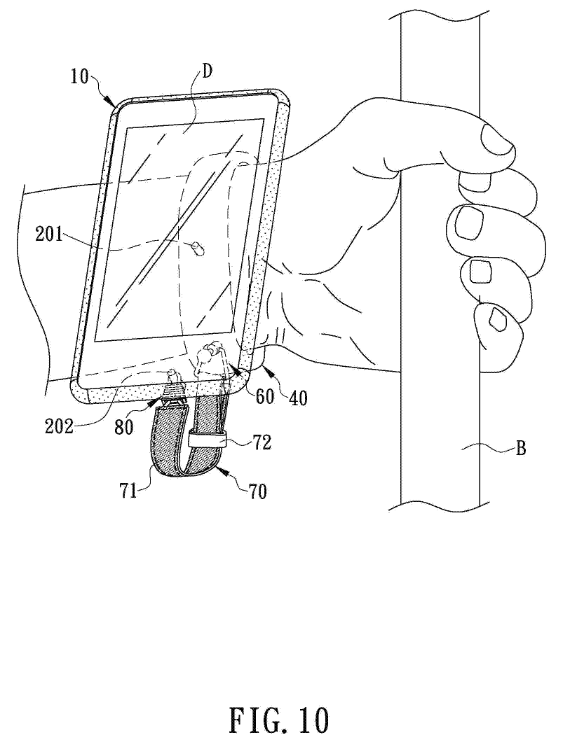

Further, in case the user must use both hands to perform work, please refer to FIGS. 1, 9 and 10, such as when the user is standing in a public transportation (such as bus, train or MRT . . .) with one hand gripping a hanging handle A or handrail B and the other hand carrying a briefcase or bag, the user only needs to embed the first stud 201 located on the rear surface of the handheld electronic device 10 into an appropriate hitch hole 41 on the wristband 40, the handheld electronic device 10 will be stably resting on the wristband 40 and not easy to be shaken under the reasons that the hitch hole 41 exerts a hitching friction respectively to the stud pillar 21 and the stud head 22 of the first stud 201 and, in the mean time, the positioning strap 70 also applies a constraining force to the second stud 202, thereby the handheld electronic device 10 is able to temporarily and stably rest on the wristband 40 within an operable and sight visible range simply through the studs 201, 202, and the position and orientation of the display screen D on the front side of the handheld electronic device 10 can also be appropriately adjusted for obtaining a better view of the information or instant message shown on the display screen D. Thus, every time when the user's both hands have to do work and are unavailable for holding the handheld electronic device 10, the handheld electronic device 10 can still be positioned on the wrist within an operable and visible range for the user to view the information or instant message displayed thereon and wouldn't be easy to be lost.

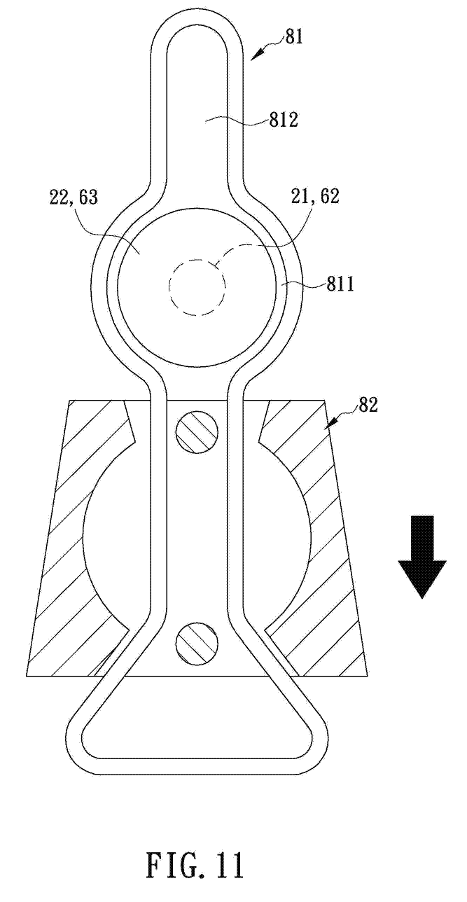

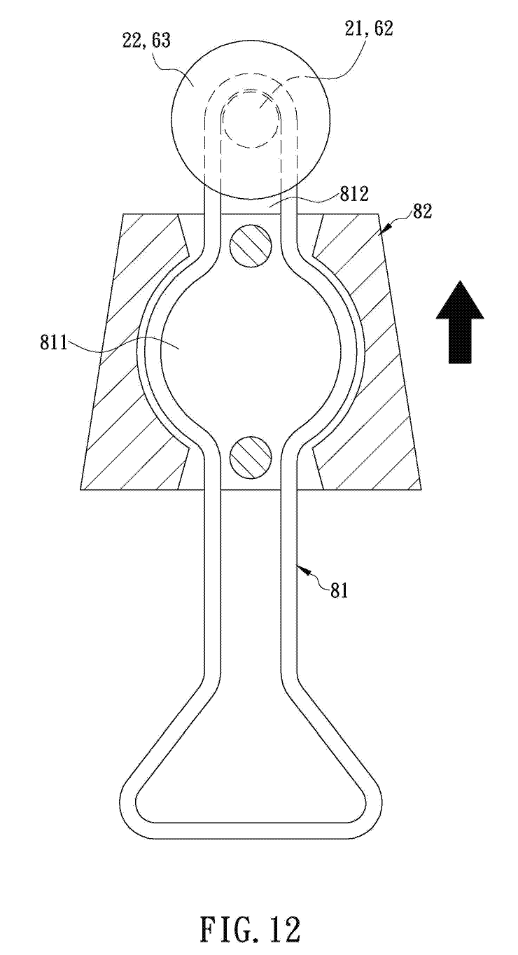

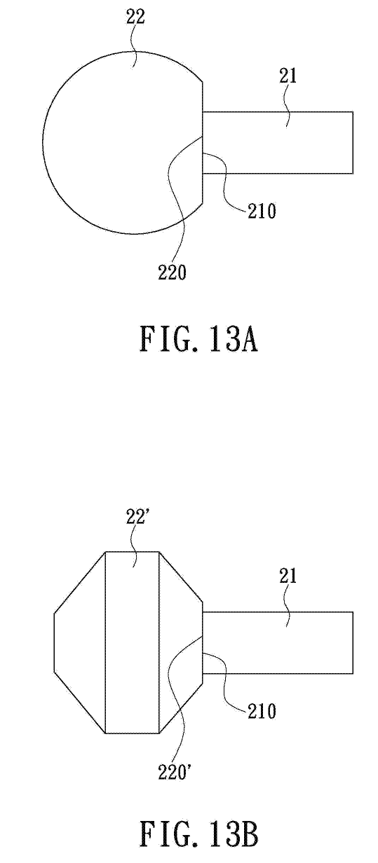

In yet another embodiment of the present invention, please refer to FIGS. 1 and 4-6, the second fastener 80 includes a male plug 81 and a female socket 82, wherein one end of the male plug 81 is fixed to the other end of the connecting strap 71, a releasing hole 811 is formed within middle portion of the male plug 81, an engaging groove 812 is formed on the male plug 81 at a position adjacent to the other end of the male plug 81, the releasing hole 811 and the engaging groove 812 are communicated with each other, the releasing hole 811 is greater than the maximum cross sections of the hitch head 63 of the hitch element 60 and the stud head 22 of the second stud 202, the width of the engaging groove 812 is smaller than the maximum cross sections of the hitch head 63 of the hitch element 60 and the stud head 22 of the second stud 202; and the female socket 82 has an inner configuration matched with an outer configuration of the male plug 81 and is capable of movably engaging with the male plug 81. Therefore, please refer to FIG. 11, when the female socket 82 is moved (along a direction of the arrow shown in FIG. 11) to a position uncovering the releasing hole 811, the stud head 22 of the second stud 202 or the hitch head 63 of the hitch element 60 can pass through the releasing hole 811 so that the stud pillar 21 of the second stud 202 or the hitch pillar 62 of the hitch element 60 can freely enter into the engaging groove 812 and be in an unlock state. Please refer to FIG. 12, when the female socket 82 is moved (along a direction of the arrow shown in FIG. 12) to a position covering the releasing hole 811 and being locked by the middle portion of the male plug 81, the stud pillar 21 or the hitch pillar 62 already entering into the engaging groove 812 is then in a lock state and unable to escape from the engaging groove 812. The above description refers only to the preferred embodiments of the second fastener 80, however, the structural characteristics of the second fastener 80 are not limited to the above description, any person skilled in the art or in the field of the present invention using the other conventional members to fasten the hitch pillar 62 of the hitch element 60 or the stud pillar 21 of the second stud 202 for positioning the positioning strap 70 to the wristband 40 or connecting the positioning strap 70 to the handheld electronic device 10 should be deemed as the aforesaid second fastener 80 of the present invention.

In yet the other embodiment of the present invention, please refer to FIG. 5-7, 13A and 13B, in order to make the stud head 22 to be easily embedded into the hitch hole 41 on the wristband 40, the configuration of the stud head 22, 22′ gradually expands from one end toward the other end and, after reaching its maximum cross section, then gradually shrinks. The configuration of the stud head 22, 22′ is preferred in sphere shape or double cone shape. In addition, in order to make the stud head 22, 22′ and the hitch hole 41 having a better hanging effect, cross section 220, 220′ of one end of the stud head 22, 22′ is greater than the cross section 210 of the other end of the stud pillar 21 so that the stud head 22, 22′ is formed as a mushroom head.

While the invention herein disclosed has been described by means of specific embodiments, numerous modifications and variations could be made thereto by those skilled in the art without departing from the scope of the invention set forth in the claims.

What is claimed is:

1. A positioning structure for a handheld electronic device, comprising:
a case being a rear case of the handheld electronic device or a protective case attached to the rear case of the handheld electronic device; and
a first stud and a second stud installed to rear side of the case along a longitudinal center line of the case and at positions adjacent to center and side edge of the case, respectively, wherein the first and second studs respectively include a stud pillar and a stud head, one end of the stud pillar is fixed to the rear side of the case, the other end of the stud pillar is connected to one end of the stud head, so that the stud head and the stud pillar are vertically standing on the rear side of the case, maximum cross section of the stud head is larger than cross section of the stud pillar, and the cross section of the stud head gradually expands from one end towards the other end thereof and, after reaching the maximum cross section of the stud head, gradually shrinks.

2. The positioning structure of claim 1, further comprises a wristband structure including a wristband having a plurality of hitch holes formed thereon along a longitudinal center line thereof, wherein the hitch holes penetrate two opposite sides of the wristband and are spaced with each other, and the hitch hole is matched with the cross section of the stud pillar;
a first fastener fixed to the wristband at a position adjacent to one end of the wristband, wherein the first fastener is configured to allow the other end of the wristband to pass therethrough and is able to fasten overlapping portions of the two ends of the wristband together, so that the wristband can then be formed as a loop;
a hitch element including a hitch pillar having one end fixed to outside of the wristband structure, a pivotal ring pivotally connected to the hitch pillar, and a hitch head having one end connected to the other end of the hitch pillar, wherein maximum cross section of the hitch head is greater than cross section of the hitch pillar;
a positioning strap hung onto the pivotal ring; and
a second fastener fixed to one end of the positioning strap, wherein the second fastener can be fastened to or released from the stud pillar or the hitch pillar.

3. The positioning structure of claim 2, wherein the positioning strap includes:
a connecting strap having a length matching with length of a user's hand; and
a retaining element fixed to the connecting strap at a position adjacent to one end of the connecting strap, so as to enable the other end of the connecting strap sequentially to pass through the pivotal ring and the retaining element and be fixed to the second fastener, so that the connecting strap is hung onto the pivotal ring, and the retaining element can apply a frictional force to the connecting strap for maintaining a hanging length of the positioning strap between the hitch element and the second fastener.

4. The positioning structure of claim 3, wherein the second fastener includes a male plug having one end fixed to the other end of the connecting strap, the male plug includes a releasing hole formed on a middle portion thereof and an engaging groove formed at a position adjacent to the other end thereof, the releasing hole is communicated with the engaging groove and is greater than the maximum cross sections of the stud head and the hitch head, respectively, and width of the engaging groove is smaller than the maximum cross sections of the stud head and the hitch head, respectively.

5. The positioning structure of claim 4, wherein the second fastener further includes a female socket having an inner configuration matched with an outer configuration of the male plug and capable of movably engaging with the male plug so that, when the female socket is moved to a position uncovering the releasing hole, the stud head or the hitch head can pass through the releasing hole for enabling the stud pillar or the hitch pillar to freely enter into the engaging groove and be in an unlock state or, when the female socket is moved to a position covering the releasing hole and locked by the middle portion of the male plug, the stud pillar or the hitch pillar already entering into the engaging groove is then in a lock state unable to escape from the engaging groove.

6. The positioning structure of claim 5, wherein the case further includes two positioning grooves recessed on the rear side of the case along the longitudinal center line of the case and at the positions adjacent to the center and side edge of the case, respectively, the first stud and the second stud further include a pivotal shaft, respectively, and the pivotal shaft is perpendicularly connected to one end of the stud pillar and installed within the positioning groove, so that the stud pillar along with the stud head can be rotated into a state to be received and lying in the positioning groove, or vertically standing on the rear side of the case outside the positioning groove.

7. The positioning structure of anyone of claim 1, wherein the first fastener includes a third stud having a third pillar and a third head, wherein one end of the third pillar is fixed to the wristband at a position adjacent to one end of the wristband, one end of the third head is connected to the other end of the third pillar, maximum cross section of the third head is greater than cross section of the third pillar, and the cross section of the third pillar is matched with the hitch hole.

8. The positioning structure of anyone of claim 2, wherein the first fastener includes a third stud having a third pillar and a third head, wherein one end of the third pillar is fixed to the wristband at a position adjacent to one end of the wristband, one end of the third head is connected to the other end of the third pillar, maximum cross section of the third head is greater than cross section of the third pillar, and the cross section of the third pillar is matched with the hitch hole.

9. The positioning structure of anyone of claim 3, wherein the first fastener includes a third stud having a third pillar and a third head, wherein one end of the third pillar is fixed to the wristband at a position adjacent to one end of the wristband, one end of the third head is connected to the other end of the third pillar, maximum cross section of the third head is greater than cross section of the third pillar, and the cross section of the third pillar is matched with the hitch hole.

10. The positioning structure of anyone of claim 4, wherein the first fastener includes a third stud having a third pillar and a third head, wherein one end of the third pillar is fixed to the wristband at a position adjacent to one end of the wristband, one end of the third head is connected to the other end of the third pillar, maximum cross section of the third head is greater than cross section of the third pillar, and the cross section of the third pillar is matched with the hitch hole.

11. The positioning structure of anyone of claim 5, wherein the first fastener includes a third stud having a third pillar and a third head, wherein one end of the third pillar is fixed to the wristband at a position adjacent to one end of the wristband, one end of the third head is connected to the other end of the third pillar, maximum cross section of the third head is greater than cross section of the third pillar, and the cross section of the third pillar is matched with the hitch hole.

12. The positioning structure of anyone of claim 6, wherein the first fastener includes a third stud having a third pillar and a third head, wherein one end of the third pillar is fixed to the wristband at a position adjacent to one end of the wristband, one end of the third head is connected to the other end of the third pillar, maximum cross section of the third head is greater than cross section of the third pillar, and the cross section of the third pillar is matched with the hitch hole.

13. The positioning structure of claim 7, the wristband structure further includes a retaining collar, the retaining collar is fixed to the wristband at a position adjacent to the third stud and, when the other end of the wristband passes through the retaining collar, the third head can be embedded into the hitch hole in a direction from the outside to the inside of the wristband so that the third pillar is positioned in the hitch hole, and the overlapping portions of the two ends of the wristband can be maintained in position by the retaining collar.

14. The positioning structure of claim 8, the wristband structure further includes a retaining collar, the retaining collar is fixed to the wristband at a position adjacent to the third stud and, when the other end of the wristband passes through the retaining collar, the third head can be embedded into the hitch hole in a direction from the outside to the inside of the wristband so that the third pillar is positioned in the hitch hole, and the overlapping portions of the two ends of the wristband can be maintained in position by the retaining collar.

15. The positioning structure of claim 9, the wristband structure further includes a retaining collar, the retaining collar is fixed to the wristband at a position adjacent to the third stud and, when the other end of the wristband passes through the retaining collar, the third head can be embedded into the hitch hole in a direction from the outside to the inside of the wristband so that the third pillar is positioned in the hitch hole, and the overlapping portions of the two ends of the wristband can be maintained in position by the retaining collar.

16. The positioning structure of claim 10, the wristband structure further includes a retaining collar, the retaining collar is fixed to the wristband at a position adjacent to the third stud and, when the other end of the wristband passes through the retaining collar, the third head can be embedded into the hitch hole in a direction from the outside to the inside of the wristband so that the third pillar is positioned in the hitch hole, and the overlapping portions of the two ends of the wristband can be maintained in position by the retaining collar.

17. The positioning structure of claim 11, the wristband structure further includes a retaining collar, the retaining collar is fixed to the wristband at a position adjacent to the third stud and, when the other end of the wristband passes through the retaining collar, the third head can be embedded into the hitch hole in a direction from the outside to the inside of the wristband so that the third pillar is positioned in the hitch hole, and the overlapping portions of the two ends of the wristband can be maintained in position by the retaining collar.

18. The positioning structure of claim 12, the wristband structure further includes a retaining collar, the retaining collar is fixed to the wristband at a position adjacent to the third stud and, when the other end of the wristband passes through the retaining collar, the third head can be embedded into the hitch hole in a direction from the outside to the inside of the wristband so that the third pillar is positioned in the hitch hole, and the overlapping portions of the two ends of the wristband can be maintained in position by the retaining collar.

19. The positioning structure of claim 13, wherein one end of the hitch pillar is fixed to outside of the retaining collar.

20. The positioning structure of claim 14, wherein one end of the hitch pillar is fixed to outside of the retaining collar.

21. The positioning structure of claim 15, wherein one end of the hitch pillar is fixed to outside of the retaining collar.

22. The positioning structure of claim 16, wherein one end of the hitch pillar is fixed to outside of the retaining collar.

23. The positioning structure of claim 17, wherein one end of the hitch pillar is fixed to outside of the retaining collar.

24. The positioning structure of claim 18, wherein one end of the hitch pillar is fixed to outside of the retaining collar.

25. The positioning structure of claim 13, wherein one end of the hitch pillar is fixed to outside of the wristband at a position adjacent to the center of the wristband.

26. The positioning structure of claim 14, wherein one end of the hitch pillar is fixed to outside of the wristband at a position adjacent to the center of the wristband.

27. The positioning structure of claim 15, wherein one end of the hitch pillar is fixed to outside of the wristband at a position adjacent to the center of the wristband.

28. The positioning structure of claim 16, wherein one end of the hitch pillar is fixed to outside of the wristband at a position adjacent to the center of the wristband.

29. The positioning structure of claim 17, wherein one end of the hitch pillar is fixed to outside of the wristband at a position adjacent to the center of the wristband.

30. The positioning structure of claim 18, wherein one end of the hitch pillar is fixed to outside of the wristband at a position adjacent to the center of the wristband.

31. The positioning structure of claim 7, the wristband structure further includes a retaining collar, the retaining collar is fixed to the wristband at a position adjacent to the other end of the wristband and, when one end of the wristband passes through the retaining collar, the third head can be embedded into the hitch hole in a direction from the inside to the outside of the wristband so that the third pillar is positioned in the hitch hole and the overlapping portions of the two ends of the wristband can be maintained in position by the retaining collar.

32. The positioning structure of claim 8, the wristband structure further includes a retaining collar, the retaining collar is fixed to the wristband at a position adjacent to the other end of the wristband and, when one end of the wristband passes through the retaining collar, the third head can be embedded into the hitch hole in a direction from the inside to the outside of the wristband so that the third pillar is positioned in the hitch hole and the overlapping portions of the two ends of the wristband can be maintained in position by the retaining collar.

33. The positioning structure of claim 9, the wristband structure further includes a retaining collar, the retaining collar is fixed to the wristband at a position adjacent to the other end of the wristband and, when one end of the wristband passes through the retaining collar, the third head can be embedded into the hitch hole in a direction from the inside to the outside of the wristband so that the third pillar is positioned in the hitch hole and the overlapping portions of the two ends of the wristband can be maintained in position by the retaining collar.

34. The positioning structure of claim 10, the wristband structure further includes a retaining collar, the retaining collar is fixed to the wristband at a position adjacent to the other end of the wristband and, when one end of the wristband passes through the retaining collar, the third head can be embedded into the hitch hole in a direction from the inside to the outside of the wristband so that the third pillar is positioned in the hitch hole and the overlapping portions of the two ends of the wristband can be maintained in position by the retaining collar.

35. The positioning structure of claim 11, the wristband structure further includes a retaining collar, the retaining collar is fixed to the wristband at a position adjacent to the other end of the wristband and, when one end of the wristband passes through the retaining collar, the third head can be embedded into the hitch hole in a direction from the inside to the outside of the wristband so that the third pillar is positioned in the hitch hole and the overlapping portions of the two ends of the wristband can be maintained in position by the retaining collar.

36. The positioning structure of claim 12, the wristband structure further includes a retaining collar, the retaining collar is fixed to the wristband at a position adjacent to the other end of the wristband and, when one end of the wristband passes through the retaining collar, the third head can be embedded into the hitch hole in a direction from the inside to the outside of the wristband so that the third pillar is positioned in the hitch hole and the overlapping portions of the two ends of the wristband can be maintained in position by the retaining collar.

37. The positioning structure of claim 31, wherein one end of the hitch pillar is fixed to outside of the retaining collar.

38. The positioning structure of claim 32, wherein one end of the hitch pillar is fixed to outside of the retaining collar.

39. The positioning structure of claim 33, wherein one end of the hitch pillar is fixed to outside of the retaining collar.

40. The positioning structure of claim 34, wherein one end of the hitch pillar is fixed to outside of the retaining collar.

41. The positioning structure of claim 35, wherein one end of the hitch pillar is fixed to outside of the retaining collar.

42. The positioning structure of claim 36, wherein one end of the hitch pillar is fixed to outside of the retaining collar.

43. The positioning structure of claim 31, wherein one end of the hitch pillar is fixed to outside of the wristband at a position adjacent to the center of the wristband.

44. The positioning structure of claim 32, wherein one end of the hitch pillar is fixed to outside of the wristband at a position adjacent to the center of the wristband.

45. The positioning structure of claim 33, wherein one end of the hitch pillar is fixed to outside of the wristband at a position adjacent to the center of the wristband.

46. The positioning structure of claim 34, wherein one end of the hitch pillar is fixed to outside of the wristband at a position adjacent to the center of the wristband.

47. The positioning structure of claim 35, wherein one end of the hitch pillar is fixed to outside of the wristband at a position adjacent to the center of the wristband.

48. The positioning structure of claim 36, wherein one end of the hitch pillar is fixed to outside of the wristband at a position adjacent to the center of the wristband.
